(19) United States
(12) Patent Application Publication
(10) Pub. No.: US 2017/0292837 A1
(43) Pub. Date: Oct. 12, 2017

(54) ADHERENT BACKED LEVEL DOT

(71) Applicant: Matthew Wade Jones, Port Orange, FL (US)

(72) Inventor: Matthew Wade Jones, Port Orange, FL (US)

(21) Appl. No.: 15/092,177

(22) Filed: Apr. 6, 2016

(51) Int. Cl. G01C 9/34

(52) U.S. Cl. CPC G01C 9/34

(57) ABSTRACT

An adherent backed level dot device includes a generally thin main body having a circular shape with a flat upper surface and a flat lower surface. One or more sealed level vials are disposed along the upper surface of the main body in a perpendicular orientation. Each of the vials include a plurality of markings, are filled with a liquid and have an air bubble suspended therein. A connector is secured along the bottom surface of the main body and functions to secure the device onto a secondary object.

### TECHNICAL FIELD

The present invention relates generally to leveling devices, and more particularly to adherent backed levels.

### BACKGROUND

The statements in this section merely provide background information related to the present disclosure and may not constitute prior art.

Levels, also called bubble levels or spirit levels, are instruments used for determining a precise horizontal or vertical surface. A level typically includes an elongated, generally rectangular-shaped main body having a flat bottom end and a raised section into which a plurality of sealed vials are secured. Each of the sealed vials contain an entrapped air bubble that is floating in a liquid. In operation, a user places the flat bottom end of the main body on or against the surface of an object, and views the position of the bubble against a series of predetermined graduated marks located on the vial. Adjustments to the object can then be made based on the location of the bubble, and the process begins again.

Although there are a great many types of commercially available bubble levels, each of these devices are designed to be used in the above described manner, wherein they repeatedly engage and disengage secondary objects. Moreover, such devices are typically employed by industries such as construction and/or interior designers, for example, so it is important that they be built from generally rugged materials that can withstand such actions over time.

However, none of these devices are particularly adapted for use with small delicate instruments, such as rifle scopes, for example, or are capable of being permanently and discretely adhered to secondary objects such as picture frames, for example. To this end, the present invention, directed to an adherent backed level differs from the conventional art in a number of aspects. The manner by which will become more apparent in the description which follows, particularly when read in conjunction with the accompanying drawings.

### SUMMARY OF THE INVENTION

The present invention is directed to an adherent backed level dot device. One embodiment of the present invention can include a generally thin main body having a flat upper surface and a flat lower surface. One or more sealed level vials can be disposed along the upper surface of the main body in any number of different orientations, so as to provide a level indication at various directions. Each of the vials can be filled with a liquid and can include an air bubble suspended therein. A plurality of markings along the vials indicate a level direction.

The device can also include a connector that is secured along the bottom surface of the main body. The connector can function to secure the device onto a secondary object such as a riffle scope or a picture frame, for example. In various embodiments the connector will include adhesives such as glue or resin that function to create a strong and non-permanent bond between the device and the exterior object.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a top view of an adherent backed level device that is useful for understanding the inventive concepts disclosed herein.

FIG. 2 is a side view of the adherent backed level device, in accordance with one embodiment of the invention.

FIG. 3 is a side view of the adherent backed level device, in accordance with another embodiment of the invention.

FIG. 4 is a perspective view of the adherent backed level device in operation, in accordance with another embodiment of the invention.

FIG. 5 is another perspective view of the adherent backed level device in operation, in accordance with another embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the term “removably secured,” and derivatives thereof shall be used to describe a situation wherein two or more objects are joined together in a non-permanent manner so as to allow the same objects to be repeatedly joined and separated. As described throughout this document, the term “complementary shape,” and “complementary dimension,” shall be used to describe a shape and size of a component that is identical to, or substantially identical to, the shape and size of another component.

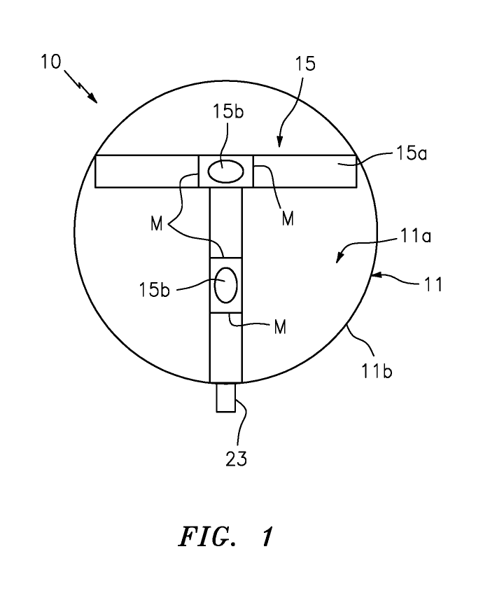

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIGS. 1-5 illustrate various embodiments of an adherent backed level dot device 10 that is useful for understanding the inventive concepts disclosed herein. As shown, the device 10 can include, essentially, a main body 11 having one or more sealed level vials 15 positioned along the top end, and a connector 20 positioned along the bottom end thereof.

The main body 11 can function as a backbone for positioning the level vial 30 directly above the connector 20. As such, the main body 11 can be constructed from any number of different shapes and materials, and can preferably include a flat upper surface 11a and a flat lower surface 11b.

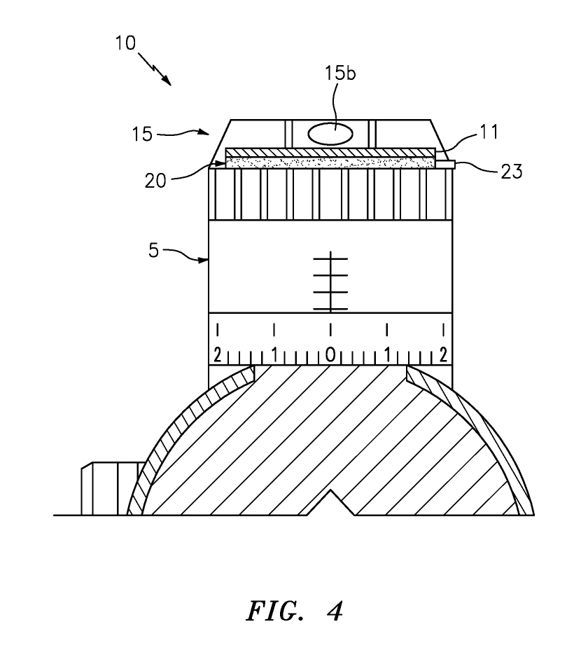

As the device 10 is intended to remain affixed to an external object for various lengths of time, it is preferred that the main body be as small and lightweight as possible. As such, in one preferred embodiment, the main body 11 can be constructed from a circular plastic wafer having a thickness of between approximately 3 and 5 millimeters, and a diameter of between approximately 12 and 40 millimeters, for example. Such dimensions are necessary for allowing the device to be mounted onto a rifle scope as described below with respect to FIG. 4. Of course, other shapes and sizes are also contemplated so as to allow the device to be utilized with other objects.

In the preferred embodiment, two sealed level vials 15 can be secured along the top surface 11a of the main body in a generally T-shaped orientation. As shown in FIG. 1, each of the level vials 15 can be filled with a fluid 15a and can have an air bubble 15b disposed therein. A plurality of markings M can be disposed along the center portion of the vials, and work in conjunction with the location of the bubble to indicate a level orientation along the plane of the vial.

Although described above as including a circular shaped main body with two vials in a T-shaped orientation, this is for illustrative purposes only, as the device can include any number of different vials which can be provided along the main body in virtually any orientation to each other. When so positioned, the main body can include any number of different shapes e.g., rectangular, square, etc., that approximate the shape of the level vial(s) so as to allow the finished device to include as small a footprint as possible.

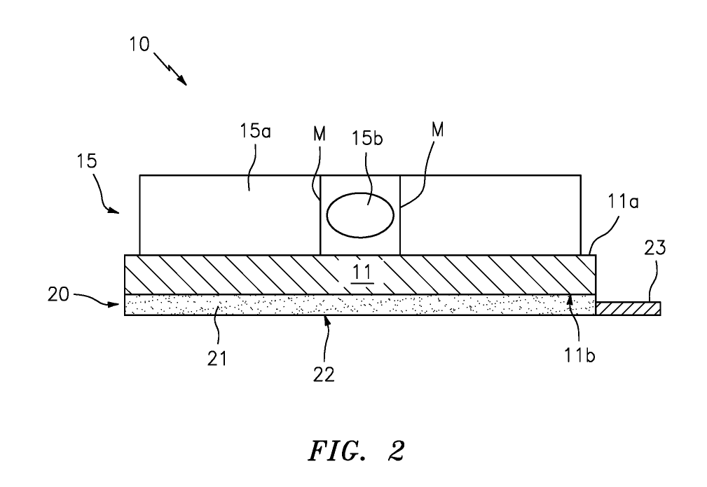

The connector 20 can function to affix the device onto the surface of an external object in either a permanent or non-permanent manner. As shown best in FIG. 2, the preferred embodiment of the connector can include an adhesive material 21 such as light binding glue or resin, for example, that is secured along an entirety of the flat bottom surface 11b and is protected by a removable adhesive cover 22 having a pull tab 23. Prior to operation, the cover 22 can be removed, thereby allowing the entire bottom end of the main body to be adhered directly onto the surface of the external object. In various embodiments, the pull tab 23 can be incorporated into the adhesive material itself, thereby allowing a user to remove the device and the adhesive simultaneously from the object.

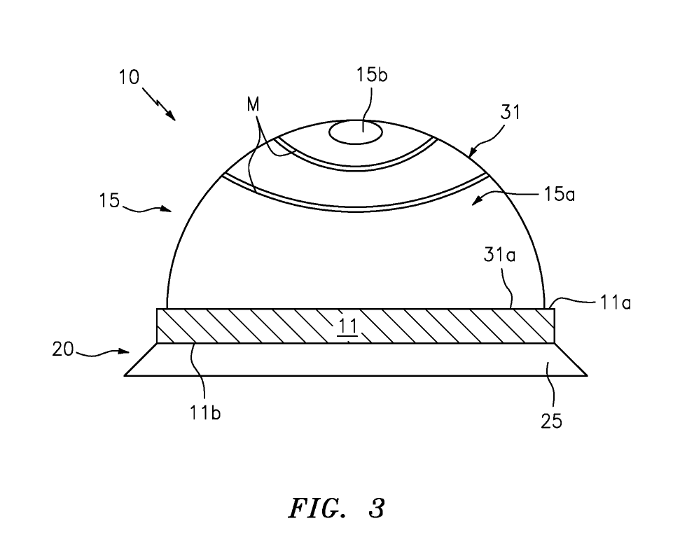

Although described above with respect to a peel and stick adhesive, those of skill in the art will recognize that the connector 20 can include any number of other known devices capable of securing the main body 11 onto a secondary object in either a permanent or non-permanent manner. Several nonlimiting examples can include suction cups (See FIG. 3), opposing strips of hook and loop material (i.e. Velcro®), and/or magnetic elements, for example. Each of these items can be permanently secured to the main body by a permanent sealer such as glue, for example, and can be permanently or removably secured to the secondary object by a permanent or non-permanent adhesive such as light glue, or tape, for example.

FIG. 3 illustrates another embodiment of the device wherein the sealed level vial 15 includes a bull's eye design that allows for the leveling of planes in two dimensions (e.g., pitch and roll). To this end, the vial can include a semi-circular clear dome 31 that is filled with a fluid 15a and having an air bubble 15b disposed therein. A plurality of circular markings M are disposed along the dome and function to indicate the direction of a level plane. As shown, the bottom end of the dome 31a can preferably include a shape/diameter that is complementary to the shape/diameter of the main body 11, thereby allowing the main body itself to secure the fluid within the dome.

By combining a lightweight level indicator 15 with a connector 20, as described above, the device 10 can function in several unique manners. As shown in FIG. 4, the circular shape of the main body 11 is designed to fit along the top surface of the elevation adjustment mechanism 5 of a rifle scope. When secured thereon via the adhesive, the device 10 can allow a user to accurately sight their scope and weapon at any time, without requiring a separate physical device.

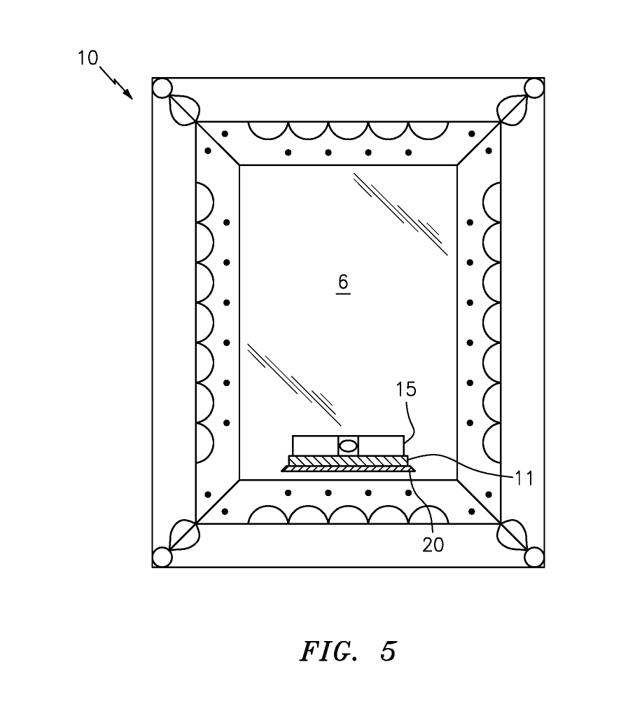

As shown in FIG. 5, the device 10 can also be utilized with any type of decorations such as the illustrated picture frame 7, for example. To this end, the connector 20 can secure the device to the frame thereby eliminating the need for the user to physically hold the device while making adjustments to the orientation of the frame. Upon completion, the user can remove the device and adhesive via the tab 23, and discard the same.

Although described above with regard to a bubble level, those of skill in the art will recognize that other level indication mechanisms can be provided without undue experimentation. As such, any number of electronic devices capable of performing the level indications described above can be used in conjunction with, or instead of the level vial(s) described above.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A level indication device, comprising:
a thin main body having a flat upper surface, a flat lower surface and a shape;
one or more sealed level vials that are permanently secured along the flat upper surface of the main body, each of the one or more level vials including a main body containing a liquid and an air bubble; and
a connector that is disposed along the flat lower surface of the main body, said connector being configured to removably secure the device onto a secondary object.

2. The device of claim 1, wherein the one or more sealed level vials include two separate vials, and the main body includes a thin circular shape.

3. The device of claim 2, wherein the two separate vials are positioned along the upper surface of the main body at a flat and perpendicular orientation to one another; and
wherein the entirety of each of the two separate vials are positioned within a periphery of the main body.

4. The device of claim 1, wherein the main body includes a thin circular shape, and the one or more sealed level vials includes a semi-circular dome forming a bull's eye level indicator.

5. The device of claim 4, wherein the semi-circular dome includes a lower diameter that is complementary to a diameter of the circular shaped main body.

6. The device of claim 1, wherein the connector comprises:
an adhesive material that is secured along the flat lower surface of the main body; and
an adhesive cover that is removably adhered to the adhesive.

7. The device of claim 6, further comprising:
a pull tab that is secured along the adhesive cover, said tab functioning to allow a user to remove the adhesive cover from the adhesive material.

8. The device of claim 6, further comprising:
a pull tab that extends outward from the adhesive material, said tab functioning to allow a user to remove the adhesive material from the secondary object.

9. The device of claim 1, wherein the connector comprises:
a suction cup having a top end that is permanently secured to the flat lower surface of the main body, and a bottom end that is configured to removably engage the secondary object.
